(19) United States
(12) Patent Application Publication
(10) Pub. No.: US 2005/0281033 A1
(43) Pub. Date: Dec. 22, 2005

(54) LED automotive headlamp

(76) Inventors: Charles Coushaine, Rindge, NH (US); Michael Tucker, Henniker, NH (US); Thomas Tessnow, Weare, NH (US); Raph Johnson, Bedford, NH (US); Steven Sidwell, Hopkington, NH (US)

Correspondence Address: William E. Meyer;Osram Sylvania Inc., 100 Endicott Street, Danvers, MA, 01923, US

(21) Appl. No.: 11/124,681

(22) Filed: May 9, 2005

Related U.S. Application Data
(60) Provisional application No. 60/580,412, filed on Jun. 17, 2004.

(51) Int. Cl. F21V 29/00

(52) U.S. Cl. 362/294

(57) ABSTRACT

An electric headlamp has a thermally conductive backplate with a support board positioned thereon. The support board has a first and a second side, and board registration areas for locating the support board. The board has registration areas formed on the backplate that cooperate with depressions formed in the second side of the support board. An array of LEDs is mounted on the first side of the support board, the LEDs pointing normal to the support board. Electrical circuitry is formed on the support board to supply power to the LEDs. A lens is associated with each LED, each lens having an input surface to receive light emitted by the respective LED, and an output surface to direct light from the LEDs in a preferred pattern. A cover encloses the respective LEDs and lenses and circumferentially seals to the backplate. The cover can be provided with a lens.

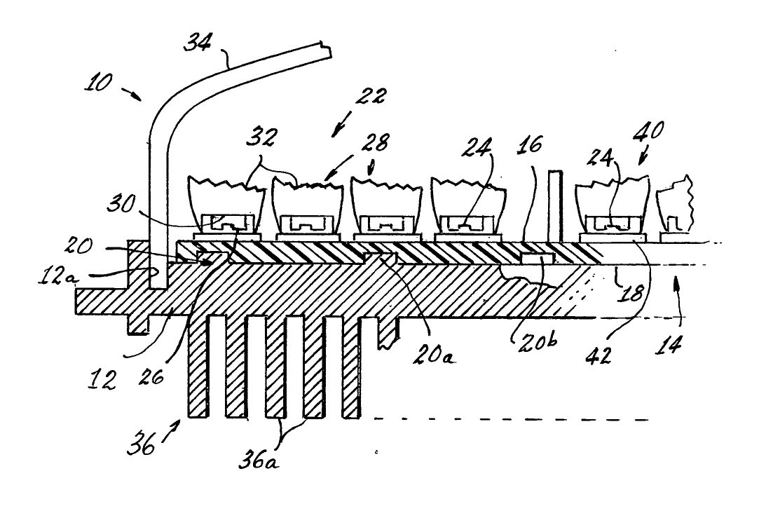

### CROSS-REFERENCE TO RELATED APPLICATIONS

This application claims priority from Provisional Patent Application Ser. No. 60/580,412, filed Jun. 17, 2004/

### TECHNICAL FIELD

This invention relates to light sources and more particularly to light sources employing light emitting diodes (LED or LEDs). Still more particularly it relates to a lamp having a high density LED array that can be used as a vehicle headlamp.

### BACKGROUND ART

LED lamps have been achieving acceptance as replacements for the more common incandescent types of lamps because of their long life and reasonable power requirements. These uses are particularly present in the automotive industry where lamps employing LEDs have been used as taillights and as stoplights, such as the required center high mount stoplight (CHMSL). However, even though the LEDs are solid state devices whose light output has increased over time, when driven at the power requirements necessary for some application, such as the aforementioned auto uses, the heat generated by the lamps becomes a problem requiring heat shields or heat dissipating additions, which increase the cost of the lamps. As the density of the LED sources increases as a function of increasing the light output of a lamp, for example, to use LEDs in headlight applications, the heat generated becomes a significant problem. Also, stacking density of the LEDs becomes a physical problem in and of itself.

One way to avoid these problems is shown in co-pending U.S. patent application Ser. No. 10/984,457, filed Nov. 9, 2004 that is assigned to the assignee of the present invention. This latter approach utilizes stacked LEDs and optical fibers to achieve a virtual point source of illumination with excellent heat dissipation. While workable, it is complex and requires good alignment between LEDs and the optics. It would be an advance in the art if LEDs could be employed for vehicle headlamps in an efficient and economical manner and provide both low and high beams.

### DISCLOSURE OF INVENTION

It is, therefore, an object of the invention to obviate the disadvantages of the prior art.

It is another object of the invention to enhance vehicle headlamps.

These objects are accomplished, in one aspect of the invention, by the provision of an electric lamp comprising: a backplate; a support board with a first side and a second side, and one or more board registrations; an array of LEDs mounted on the first side of the support board; the LEDs being oriented to generally point normal to the support board; electrical circuitry formed on the support board to supply power to the LEDs; a respective LED lens for each of the respective LEDs, the lens having an input surface to receive light emitted by the respective LED, and an output surface formed to direct light form the LED in a preferred pattern; and a cover enclosing the respective LED lenses and circumferentially sealing with the backplate.

In a preferred embodiment the lamp can comprise two arrays of LEDs, each with its own circuit, so that both low and high beams can be provided when the lamp is used as a vehicle headlamp.

### BRIEF DESCRIPTION OF THE DRAWINGS

The single FIGURE is a diagrammatic illustration of an embodiment of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

Referring now to the drawings with greater particularity, there is shown in the figure an electric lamp 10, for example, a headlamp for a vehicle. The lamp 10 has a backplate 12 of a suitable, thermally conductive material, such as aluminum, with a support board 14 positioned thereon. The support board 14 has a first side 16 and a second side 18, and one or more board registration areas 20 for locating the support board on the backplate. As shown, the board registration areas 20 comprise protuberances 20a formed on the backplate that cooperate with depressions 20b formed in the second side 18 of the support board.

An array 22 of LEDs 24 is mounted on the first side 16 of the support board 14, the LEDs being oriented to generally point normal to the support board 14. The array can be in X-Y matrix format or other configuration. Electrical circuitry 26 (shown diagrammatically) is formed on the first side 16 of the support board 14 to supply power to the LEDs. Power to the electrical circuitry can be supplied by any convenient method.

A lens 28 is associated with each of the respective LEDs 24, the lenses 28 having an input surface 30 to receive light emitted by the respective LED, and an output surface 32 formed to direct light from the LED 24 in a preferred pattern. A cover 34 encloses the respective LEDs 24 and lenses 28 and circumferentially seals to the backplate 12 via a groove 12a. If desired, the cover 34 can also be provided with a lens or lenses. Alternatively, a single lens covering more than one LED 24 can replace the individual lenses 28.

The backplate 12 includes heat sink 36, which can be in the form of a plurality of heat dissipating fins 36a.

In a preferred embodiment of the invention each LED lens 28 is individually formed and supported in registration with the support board 14.

For the electric lamp 10 to function as an all-inclusive vehicle headlamp, there is provided a second array 40 of LEDs 24 similarly mounted and lensed and electrically coupled to a second electrical circuit 42, providing a second operative lamp in the same enclosure. In this instance, one array can function as a low beam and the other array can function as a high beam. Alternatively, additional arrays can be provided to, for example, enhance illumination while the vehicle is turning.

Thus there is provided an electric lamp employing LEDs that have good heat dissipation and no requirement for light guides such as optical fibers.

While there have been shown and described what are present considered to be the preferred embodiments of the invention, it will be apparent to those skilled in the art that various changes and modifications can be made herein without departing from the scope of the invention as defined by the appended claims.

1. An electric lamp comprising:
a backplate;
a support board with a first side and a second side, and one or more board registrations;
an array of LEDs mounted on the first side of the support board; the LEDs being oriented to generally point normal to the support board;
electrical circuitry formed on the support board to supply power to the LEDs;
a respective LED lens for each of the respective LEDs, the lens having an input surface to receive light emitted by the respective LED, and an output surface formed to direct light from the LED in a preferred pattern, and
a cover enclosing the respective LED lenses and circumferentially sealing with the backplate.

2. The electric lamp of claim 1, wherein the backplate includes heat sink.

3. The electric lamp of claim 1, wherein each LED lens is individually formed and supported in registration with the support board.

4. The electric lamp of claim 1, wherein the support board is planar.

5. The electric lamp of claim 1, wherein there is a second array of LEDs similarly mounted and lensed, electrically coupled to a second electrical circuit providing a second operative lamp in the same enclosure.

6. The electric lamp of claim 1, wherein the lamp is a vehicle headlamp.

7. The electric lamp of claim 5 wherein the lamp is a vehicle headlamp.
